(19) United States
(12) Patent Application Publication
(10) Pub. No.: US 2007/0078715 A1
(43) Pub. Date: Apr. 5, 2007

(54) Advertisement display processing method and apparatus associated with reproduction title

(76) Inventor: Masatoshi Murakami, Hamura-shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/520,954

(22) Filed: Sep. 13, 2006

(30) Foreign Application Priority Data
Oct. 4, 2005 (JP) 2005-291429

(51) Int. Cl. G06Q 30/00; H04N 7/10

(52) U.S. Cl. 705/14; 725/32

(57) ABSTRACT

For individual users, information which is the latest and which is suitable to the users can be properly displayed or can be selectively displayed. A reproduction title is detected as a title of a recorded broadcast program and/or one of the user use states of distributed content titles such as titles recorded in a DVD, CD, etc. When an information processing operation is made in accordance with information such as a broadcast channel code at the time of recording and a broadcasting date and time, or the detection of the reproduction title. If a reproduction title is selected, the specific information is sent to a server via a communication line. Then, a user side client device acquires from the server, advertisement information relating to or associated with the specific information that has been sent, and displays the acquired information.

### CROSS-REFERENCE TO RELATED APPLICATIONS

This application is based upon and claims the benefit of priority from Japanese Patent Application No. 2005-291429, filed Oct. 4, 2005, the entire contents of which are incorporated herein by reference.

### BACKGROUND OF THE INVENTION

1. Field of the Invention

One embodiment of the invention relates to an advertisement display processing method and apparatus associated with a reproduction title.

2. Description of the Related Art

In recent years, a digital video recorder represented by a DVD has been widely prevalent in place of a traditional analog video cassette recorder. In such a digital video recorder, EPG (Electronic Program Guide) or DEPG (Dynamic Electronic Program Guide) and other electronic information is available for use in program viewing or program recording of a TV program.

Such electronic information of available for use other than display of a broadcast program. An example of such use includes forcible display of an advertisement for a viewer such as a user. Unfortunately, there is a possibility that an advertisement or commercial message (CM) becomes obsolete at the time of reproduction. For example, it is meaningless to provide a CM of a car which is already obsolete at the time of reproduction.

In addition, in such systems, a CM is displayed regardless of a user's gender or age and preference, and there is a low possibility that the desired effect of such a CM is attained. For example, if a CM of a graveyard or a Buddhist altar is provided to teenagers or young people in their 20s, the advertisement effect cannot be expected. In addition, if a CM is provided while ignoring a user's gender or age and preference, an effect of such CM is unknown.

Furthermore, if a user who has viewed a CM becomes interested in an advertised commodity, such a user cannot purchase it on the spot, and there is a possibility that an effect of such a CM is lowered. For example, an impulse purchases cannot be induced, and then, there is also a possibility that the user's interest drops significantly with time.

### SUMMARY OF THE INVENTION

For purposes of summarizing the invention, certain aspects, advantages, and novel features of the invention have been described herein. It is to be understood that not necessarily all such advantages may be achieved in accordance with any particular embodiment of the invention. Thus, the invention may be embodied or carried out in a manner that achieves or optimizes one advantage or group of advantages as taught herein without necessarily achieving other advantages as may be taught or suggested herein.

### BRIEF DESCRIPTION OF THE DRAWINGS

FIG. 1 is an exemplary view illustrating a configuration of a recording/reproducing apparatus using an electronic program chart according to one embodiment of the invention;

FIG. 2 is an exemplary view illustrating an example of a remote controller that can be used for operation of the apparatus shown in FIG. 1;

FIG. 3 is an exemplary view illustrating a display screen example of a main menu obtained by a method according to one embodiment of the invention using an electronic program chart;

FIG. 4 is an exemplary view illustrating a display example of a program guide that can be moved from the main menu shown in FIG. 3;

FIG. 5 is an exemplary view illustrating a display example of a program list that can be moved from the main menu shown in FIG. 3;

FIG. 6 is an exemplary view illustrating a display example in the case where an advertisement exists;

FIG. 7 is an exemplary view illustrating an example of advertisement display associated with a title on a cursor;

FIG. 8 is an exemplary view illustrating an example of a system configuration to which the recording/reproducing method according to one embodiment of the invention is applied;

FIG. 9 is an exemplary view illustrating an operational example of the system configuration shown in FIG. 8;

FIG. 10 is an exemplary view illustrating a specific example of title information;

FIG. 11 is an exemplary view illustrating a specific example of advertisement information;

FIG. 12 is an exemplary flow chart illustrating a specific example of a display processing operation of advertisement information;

FIG. 13 is an exemplary flow chart illustrating a specific example of an advertisement acquisition processing operation from a server;

FIG. 14 is an exemplary flow chart illustrating a specific example of a processing operation of updating information indicating the presence or absence of an advertisement mark of a title;

FIG. 15 is an exemplary flow chart illustrating a specific example of a processing operation of displaying an advertisement mark on a title;

FIG. 16 is an exemplary view illustrating an example of a flag attached to an icon of a thumbnail or its illustrative text in the case where there is an advertisement which a user has not viewed yet;

FIG. 17 is an exemplary flow chart illustrating a specific example of a processing operation of acquiring a difference in advertisement information from a server;

FIG. 18 is an exemplary flow chart illustrating a specific example of a processing operation that causes a user to select reproduction of a title or advertisement display associated with the title;

FIG. 19 is an exemplary flow chart illustrating a specific example of a processing operation of displaying advertisement information in accordance with a recording tile that appears at a cursor position on a display screen; and

FIG. 20 is an exemplary view illustrating a display example of a title thumbnail list in the case where an advertisement exists.

### DETAILED DESCRIPTION OF THE PREFERRED EMBODIMENTS

An embodiment of the invention can provide a method and apparatus capable of properly displaying or selectively displaying information which is the latest and which is suitable to individual users, and providing information which has not been generally obtained or which may be easily missed.

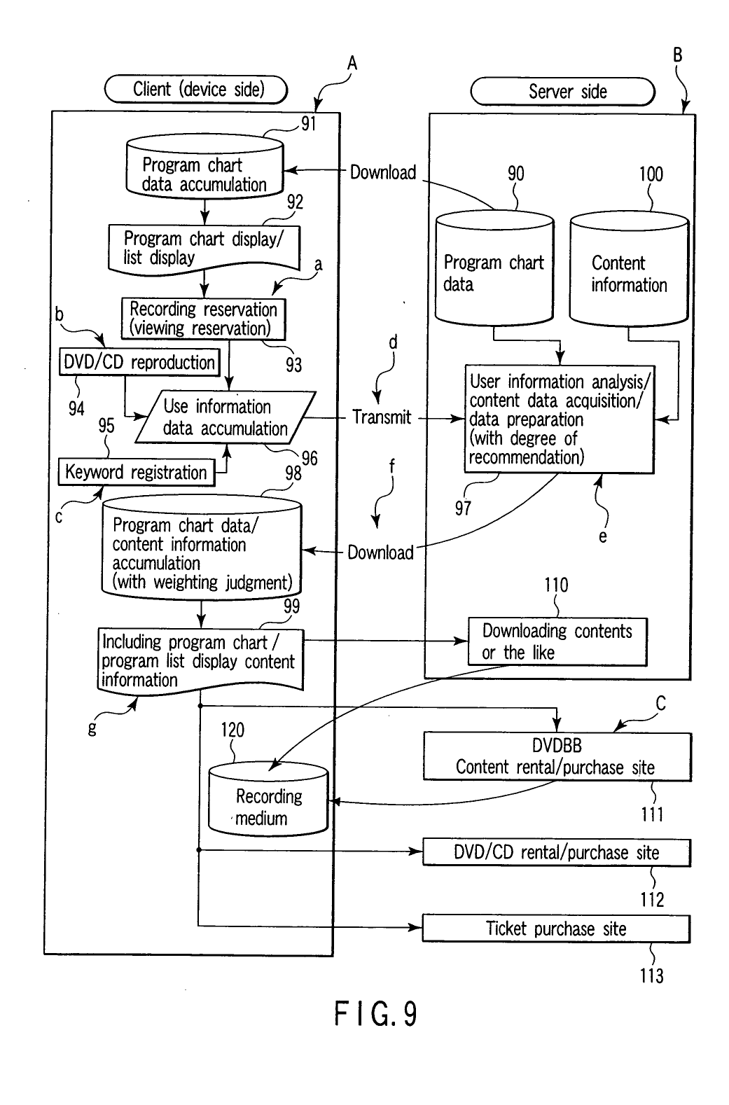

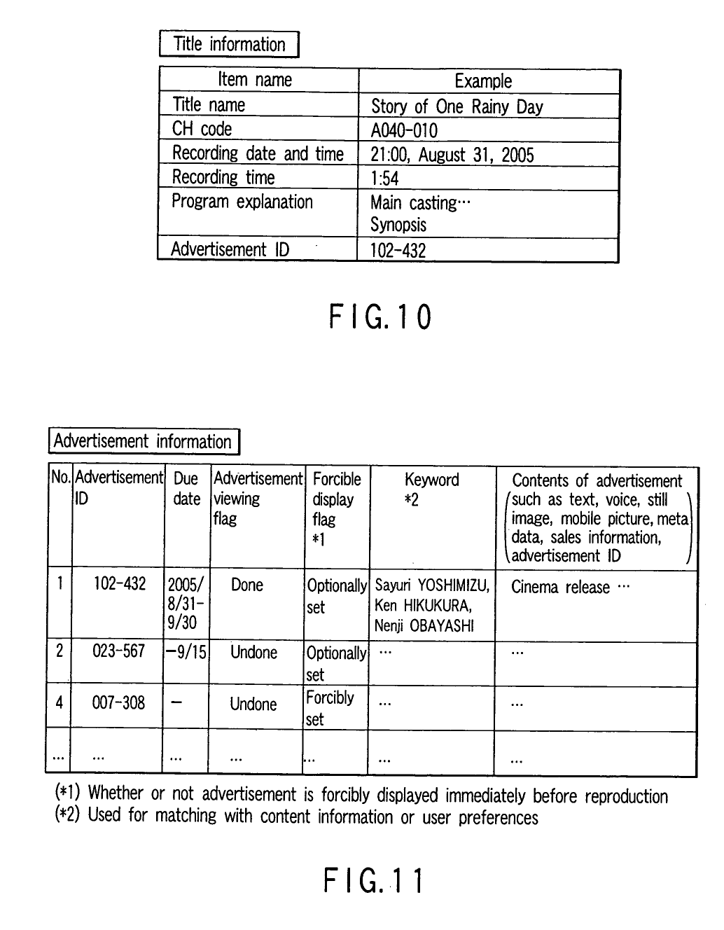

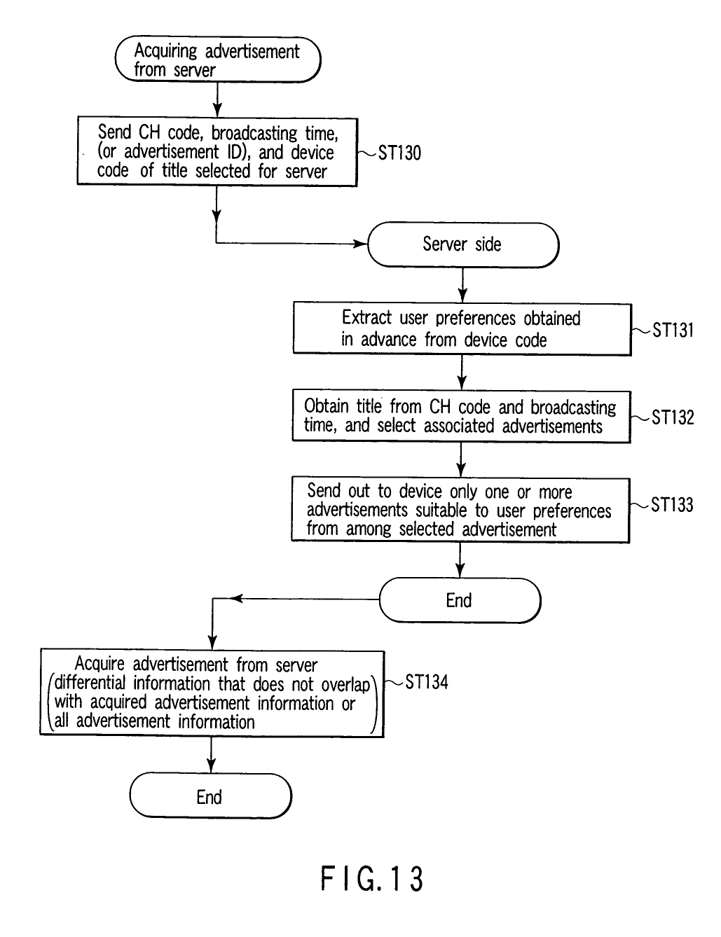

In an advertisement display processing method according to one embodiment of the invention, a reproduction title is detected as a title of a recorded broadcast program and/or one of user use states of distributed content titles such as titles recorded in DVD or CD and the like (96 shown in FIG. 9). At the time of carrying out information processing operations (97 to 99) in accordance with specific information such as a broadcast channel code at the time of recording or date and time of broadcasting, that can specify the thus detected reproduction time, if a certain reproduction title is selected, the specific information (FIG. 10) is sent to a server via a communication line (ST130 shown in FIG. 13). Then, user side client equipment acquires from the server advertisement information (FIG. 11) relevant to or associated with the sent specific information (ST134 shown in FIG. 13), and the user side displays the acquired advertisement information (99 shown in FIG. 9).

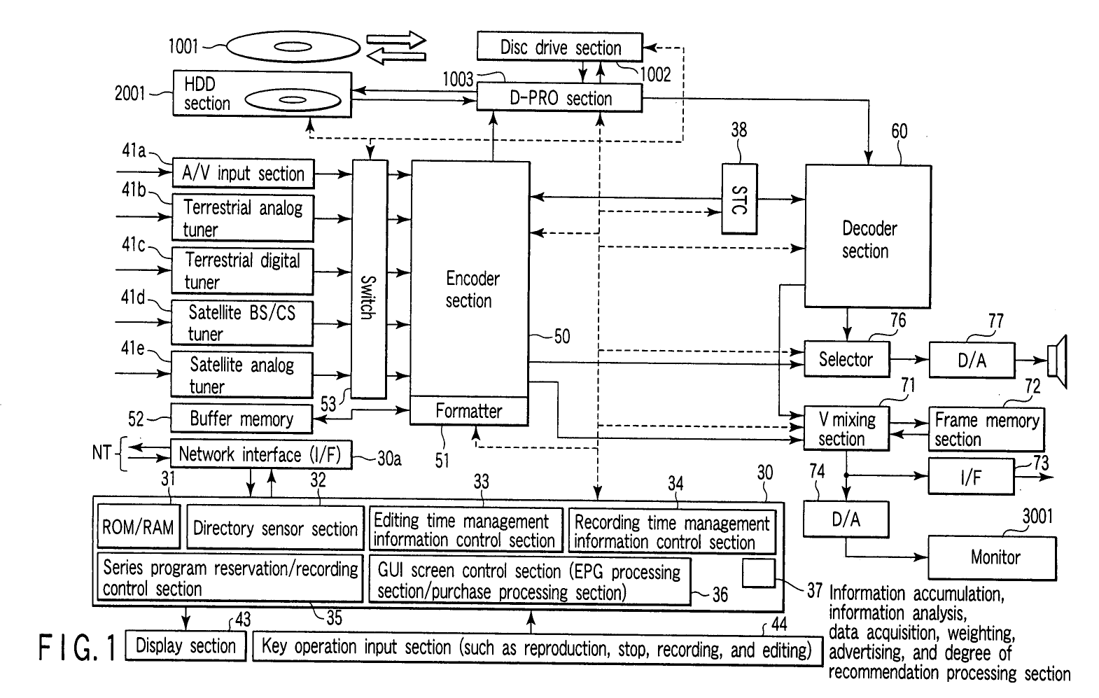

Now, embodiments of the invention will be described here with reference to the accompanying drawings. First, an overview of a recording/reproducing apparatus to which the invention has been applied will be described with reference to FIG. 1. In FIG. 1, a recording medium, or an information storage medium is shown as a device capable of handling both of an optical disc and a hard disk such as DVD-RAM, DVD±RW, DVD±R, DVD-ROM, DVD video, CD-RW, CD-R, or CD-ROM, music CD. These hard disks and optical discs may be replaced with, or may be used together with, another recording medium such as a semiconductor memory.

In a configuration shown in FIG. 1, when blocks are roughly divided, the left side indicates a main block configuration of a recording system, and the right side indicates a main block configuration of a reproducing system. The recording/reproducing apparatus shown in FIG. 1 has two types of disc/disk drive sections, i.e., a disc drive section 1002 and a hard disk drive section 2001. The disc drive section 1002 rotationally drives an optical disc 1001 serving as a first medium capable of constructing a video file, and executes information reading and/or writing. The disc drive section 1002 has a rotation control system, a laser drive system, an optical system and the like relevant to the optical disc 1001. In addition, the hard disk drive section 2001 drives a hard disk serving as a second medium.

A data processor section 1003 can supply recording data to the disc drive section 1002 and the hard disk drive section 2001 and receive a reproduced signal. The data processor section 1003 handles data defined in units of recording or reproducing, and includes a buffer circuit, a modulation/demodulation circuit, an error correcting section and the like.

In addition, the recording/reproducing apparatus shown in FIG. 1 comprises: an encoder section 50 that configures a recording side; a decoder section 60 that configures a reproducing side; and a microcomputer block 30 that controls an operation of an equipment main body as the primary constituent elements. The encoder section 50 includes a transport stream processor section and a plurality of MPEG encoders.

The encoder section 50 has: a video and audio use analog digital converter that basically digitizes an analog video signal or an analog audio signal that have been inputted; a video encoder; and an audio encoder. Further, this encoder section can include a subsidiary picture encoder that represents subtitles or an icon as bit map data as needed.

An encode output from the encoder section 50 is converted into a predetermined DVD-RAM format at a formatter 51 that includes a buffer memory, and then, the converted output is supplied to the data processor section 1003 described previously. Alternatively a format conversion may not be carried out such as in the case where a digital broadcast transport stream (MPEG2-TS) is recorded as a stream, and the recorded stream is supplied to the data processor section 1003 described previously. A packet elementary stream sampled from the transport stream may be directly recorded from the encoder section 50 to a hard disk of the hard disk drive section 2001.

The encoder section 50 can input an external analog video signal and an external analog audio signal from an AV input section 41a via a switch (signal selector) 53. In addition, a receiving one or more signals from a terrestrial analog tuner 41b, a terrestrial digital tuner 41c, a satellite BS/CS tuner 41d, and a satellite analog tuner 41e can be selectively inputted to the encoder section 50.

In the case where the encoder section 50 includes two MPEG encoders, for example, a program received by the terrestrial analog tuner 41b can be recorded as DVD-VR by the hard disk drive section 2001, and at the same time, a program received by the satellite analog tuner 41e can be recorded as DVD-VR by the hard disk drive section 2001 or the optical disc 1001. In addition, even in the case where the encoder section 50 has only one MPEG encoder, a program (MPEG2-TS) received by the terrestrial digital tuner 41c is recorded as a stream by the hard disk drive section 2001, and at the same time, a program received by the terrestrial analog tuner 41b can be recorded and viewed as DVD-VR by the hard disk drive section 2001 or the optical disc 1001.

When a compressed or encoded digital video signal or digital audio signal is directly inputted, the encoder section 50 can directly supply the compressed digital video signal or digital audio signal to the formatter 51. In addition, the encoder section 50 can directly supply an analog/digital converted digital video signal or audio signal to a video mixing section 71 or an audio selector 76.

In the MPEG video encoder included in the encoder section 50, a digital video signal is compressed at a variable bit rate which is based on MPEG2 standard or MPEG1 standard, and the compressed signal is converted into a digital video signal to be recorded in a hard disk or an optical disc. This digital audio signal is further converted into a digital audio signal compressed at a fixed bit rate based on MPEG standard or AC-3 standard, or alternatively, a digital audio signal of non-compression linear PCM.

In the case where a subsidiary picture signal has been inputted from the AV input section 41a, such as when a signal is inputted from a DVD video player with an independent output terminal for subsidiary picture signals. F, for example, or alternatively, in the case where a DVD video signal having such a data structure has been broadcast and received by the TV tuner section 42, the subsidiary picture signal included in the DVD video signal is encoded by a subsidiary picture encoder such as run-length encoding based on DVD standard, and is obtained as subsidiary picture bit map data.

The encoded digital video signal, digital audio signal, and subsidiary picture data are packed at the formatter 51, and the packed signals are produced as a video pack, an audio pack, and a subsidiary picture pack. Further, these packs are collected, and then, are converted into a format defined in DVD Video standard (a DVD-Video format) or a format defined in a DVD-recording standard (a DVD-VR format). The formatter 51 uses a buffer memory 52 as a work area when the above-described conversion processing operation is made.

The equipment shown in FIG. 1 can supply information formatted by the formatter 51 such as video, audio, and subsidiary picture data packs and produced management information to the hard disk drive section 2001 and/or the data disc drive section 1002 via the data processor section 1003, and then, record the supplied information in the hard disk or the optical disc 1001. In addition, this equipment can record the information recorded in the hard disk or the optical disc 1001 via the data processor section 1003 or the disc drive section 1002.

In addition, this equipment can carry out an edit processing operation of partially deleting video objects of a plurality of programs recorded in the hard disk or the optical disc 1001 or connecting objects of different programs from each other.

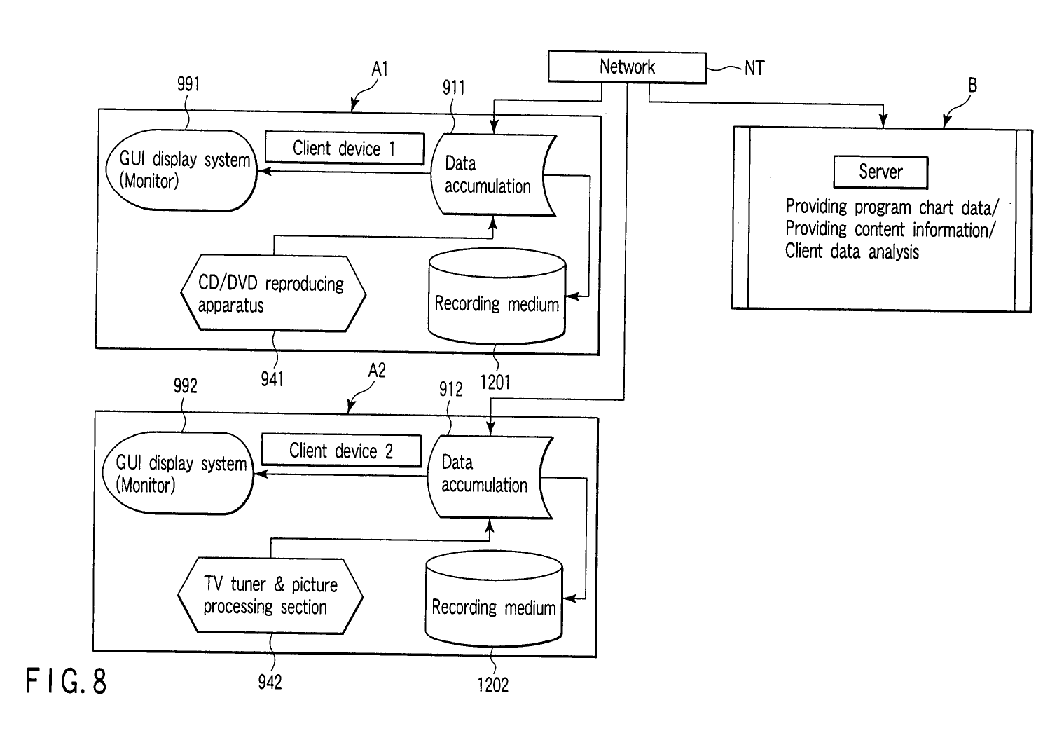

A microcomputer block 30 includes: an MPU (Micro Processing Unit) or a CPU (Central Processing Unit); a ROM having a control program or the like written therein; a RAM or the like for providing a work area to execute a program. The microcomputer block 30 can capture information contained in an electronic program chart including a variety of information services as well as a broadcast program, from electronic program services of a terrestrial analog broadcast such as ADAMS: TV-Asahi Data and Multimedia Service in Tokyo area or electronic guide information/electronic program guide (EPG) of a terrestrial/satellite digital broadcast. In addition, the microcomputer block 30 can be connected to an external network NT via a network interface 30a. In this manner, electronic program guide information (DEPG) can be captured from an external server (B shown in FIG. 8 or FIG. 9 described later).

Further, the MPU of the microcomputer block 30 uses a RAM as a work area in accordance with a control program or firmware stored in its ROM, and executes faulty location detection, unrecorded area detection, recording information recording location setting, UDF recording, AV address setting and the like. In addition, the microcomputer block 30 has an information processing section to integrally control each of the blocks of the equipment. This microcomputer block comprises: a work RAM 31; a directory detecting section 32; a VMG (whole video management information) information producing section; a copy-relating information sensor section; a copy and scramble information processing section (an RDI processing section); a packet header processing section; a sequence header processing section; an aspect ratio information processing section and the like. In addition, the microcomputer block 30 comprises: a control section 34 for controlling management information at the time of executing recording and a control section 33 for controlling management information at the time of executing editing.

Further, the microcomputer block 30 provides: a series program reservation/recording control section 35; and a GUI (Graphics User Interface) screen control section 36. A description will be given later with respect to operations of the series program reservation/recording control section 35 and the GUI screen control section including for example, an EPG processing section, a purchase processing section and the like.

From among a result of execution of the MPU of the microcomputer block 30, the contents to be notified to a user are displayed on a display section 43 of a picture data recording/reproducing apparatus or are displayed as an OSD (On Screen Display) on a monitor display 3001.

In addition, the microcomputer block 30 has a key input section 44 that assigns an operating signal for operating this equipment. This key input section 44 is equivalent to operating switches provided on the main body of the recording/reproducing apparatus, for example, or alternatively, a remote controller. In addition, a personal computer connected to the recording/reproducing apparatus by using means or devices such as wire communication, wireless communication, optical communication, infrared-ray communication or the like can be used to operate the equipment shown in FIG. 1. In any aspect, a user operates this key input section 44, thereby making it possible to carry out a processing operation of recording a received or inputted picture or voice signal, a processing operation of reproducing the recorded contents or optical disc data, or a processing operation of editing the recorded contents.

A timing for the microcomputer block 30 to control the disc drive section 1002, the hard disk drive section 2001, the data processor section 1003, the encoder section 50, and/or the decoder section 60 can be executed based on time data from an STC (System Time Clock) 38. Although a recording or reproducing operation is generally executed in synchronism with a time clock from the STC 38, other processing operations may be executed at a timing which is independent of such a time clock of the STC 38.

Although not shown, the decoder section 60 has: a separator for separating and capturing packs from signals in a DVD format having a pack structure; a memory used at the time of executing pack separation or any other signal processing operation; a V decoder for decoding main picture data (contents of video pack) separated by the separator; a subsidiary picture decoder for decoding the subsidiary picture data (contents of subsidiary picture pack) separated by the separator; and an A decoder for decoding audio data (contents of audio pack) separated by the separator. The decoder section 60 also comprises a video processor for properly combining the decoded subsidiary picture on the decoded main picture, and then, outputting a menu, a highlight button, subtitles, or any other subsidiary picture on the main picture in a superimposed manner.

An output video signal of the decoder section 60 is inputted to the video mixing section 71. The video mixing section 71 carries out combining of text data, for example. In addition, a line for directly capturing a signal from a TV tuner or the AV input section 41a is also connected to the video mixing section 71. A frame memory 72 used as a buffer is connected to the video mixing section 71. In the case where an analog output is forwarded from the video mixing section 71, such output is externally forwarded via an I/F (interface) 73. In the case of a digital output, such output is externally forwarded via a digital/analog converter 74.

An output audio signal of the decoder section 60 is converted into an analog signal using (or by means of) a digital analog converter 77 via a selector 76, and the converted signal is externally outputted. The selector 76 is controlled with (or by means of) a select signal from the microcomputer block 30. In this manner, the selector 76 can directly select a signal through the encoder section 50 at the time of directly monitoring a digital signal from the TV tuners 41b to 41e or the AV input section 41a.

The formatter 51 of the encoder section 50 produces isolated items of information during recording, and then, periodically sends it to the MPU of the microcomputer block 30 such as information produced at the time of interruption at the beginning of GOP or the like. The separated items of information include: VOBU pack number, an end address of I-picture from the beginning of VOBU; a VOBU reproduction time and the like.

At the same time, an aspect information processing section sends information to an MPU at the time of starting recording, and the MPU produces VOB stream information (STI). STI stores resolution data, aspect data and the like, and at the time of reproduction, each decoder section carries out initial setting based on this information.

In addition, in this equipment, one video file recorded in DVD is handled in one disc. In addition, during data access (seek), a minimally continuous information unit (size) is determined in order to continue reproduction without any intermission. This unit is referred to as a CDA (Contiguous Data Area). The CDA size is a multiple of an ECC (Error Correction Code) blocks (16 sectors), and a file system carries out recording in units of CDA.

The data processor section 1003 receives data defined in units of VOBU from the formatter of the encoder section 50, and supplies the data defined in units of CDA to the disc drive section 1002 or the hard disk drive section 2001. In addition, when the MPU of the microcomputer block 30 produces management information to reproduce recorded data, and then, recognizes a command indicating the end of data recording, this MPU sends the produced management information to the data processor section 1003. In this manner, management information is recorded in a disc. Therefore, when encoding is carried out, the MPU of the microcomputer block 30 receives information defined in units of data, such as isolated information, from the encoder section 50. In addition, the MPU of the microcomputer block 30 recognizes management information (file system) read from an optical disc and a hard disk at the time of starting recording; recognizes an unrecorded area of each disc or disk; and sets a recording area on data in the disc via the data processor section 1003.

The equipment shown in FIG. 1 includes: a block (36) for carrying out a processing operation of displaying electronic guide information obtained via a broadcast and/or a communication line; a block (50 and 51, 1001 to 1003, and 2001) for carrying out a processing operation of recording a broadcast program or a computer program that corresponds to the electronic guide information; and a block (37) for detecting a title reproduced from among one or more titles included in the recorded broadcast program or computer program, and carrying out an advertisement display processing operation in accordance with advertisement information (FIG. 11) associated with the thus detected reproduction title.

In addition, a picture receiver device such as a digital TV including main sections of the equipment shown in FIG. 1 includes: a block (36) for carrying out a processing operation of displaying electronic guide information obtained via a broadcast and/or a communication line; tuners (41b to 41e) for receiving a broadcast; a monitor (3001) for displaying on a screen a picture of the information processed by the block (36) for carrying out the display processing operation and/or a picture of broadcast received by the tuners; and a block (37) for detecting a title reproduced from among one or more titles included in the recorded broadcast program or computer program, and then, carrying out an advertisement display processing operation in accordance with advertisement information (FIG. 11) associated with the thus detected reproduction title.

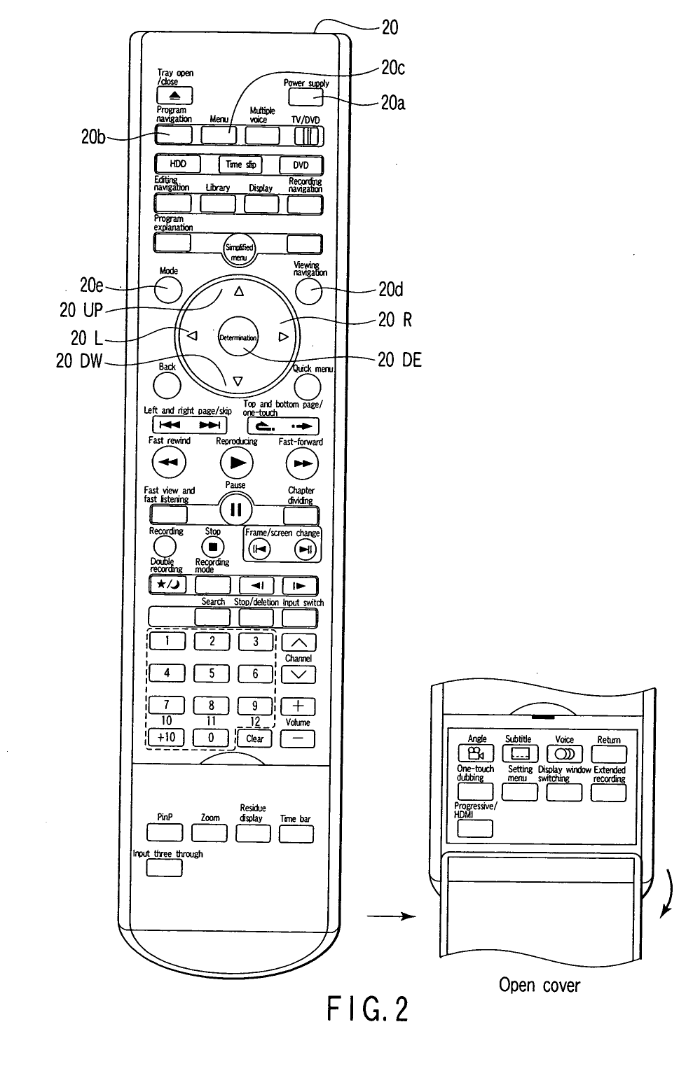

FIG. 2 illustrates an overview of a remote controller 20. Now, main operating keys are described here. Reference numeral 20a denotes a power supply key for turning ON/OFF power supply; and reference numeral 20b denotes a program navigation key for starting up program navigation. (Reference numeral 20b may be used as a top menu key for displaying a top menu screen). A menu key 20c is provided as an operating key to be operated when displaying a menu recorded in a medium such as DVD, for example. Reference numeral 20DE denotes a determination key, and reference numerals 20UP, 20DW, 20R, and 20L denote cursor operating keys for moving a cursor upwardly, downwardly, right and left, respectively.

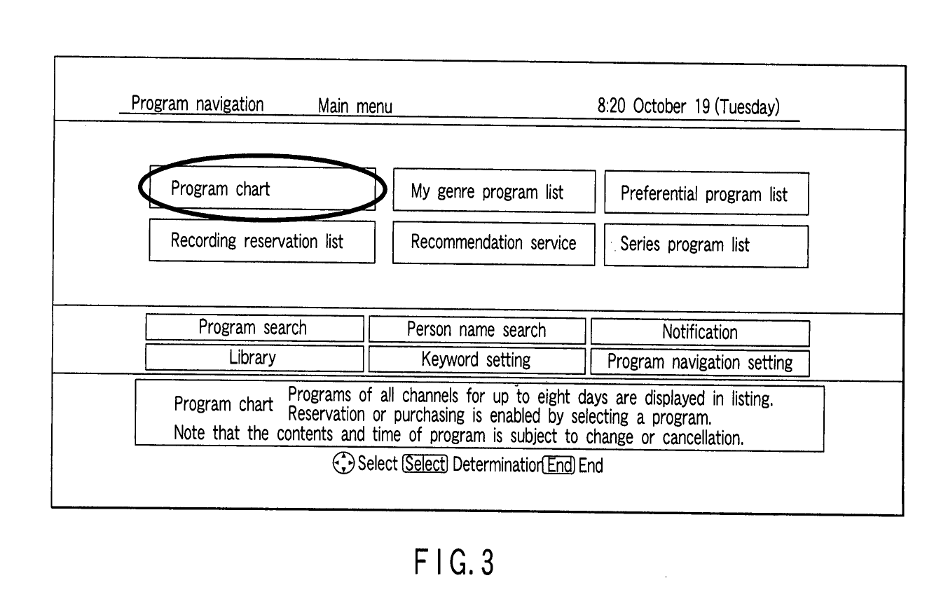

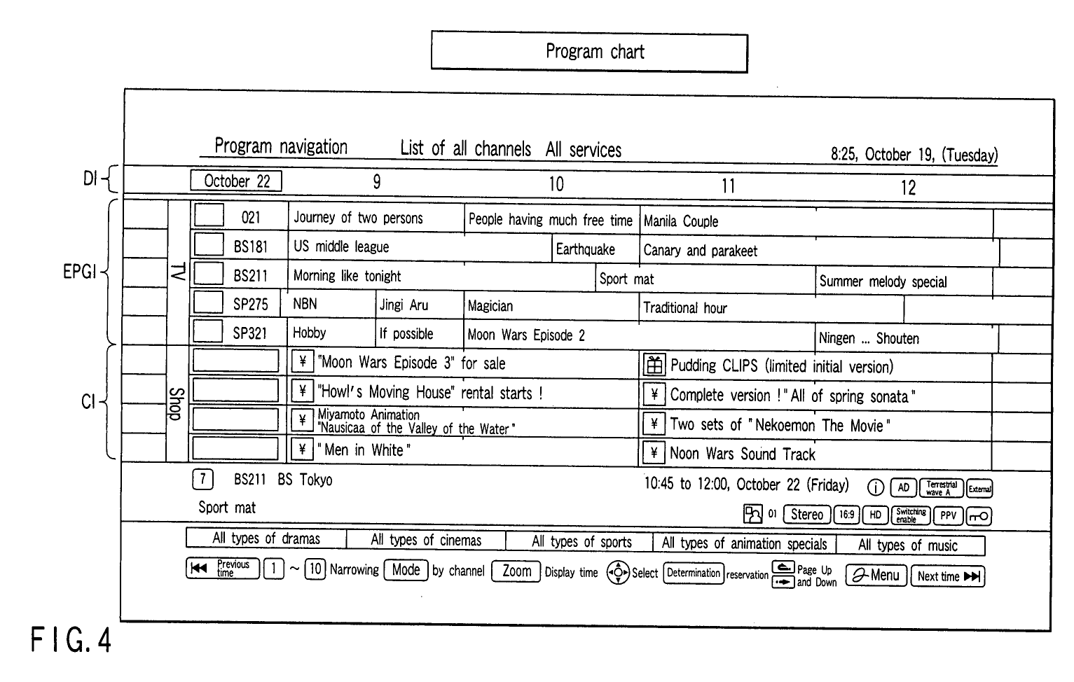

Now, a description will be given with respect to a characterizing configuration and operation relevant to an operation using display of an electronic program chart (electronic guide information) in the equipment shown in FIG. 1. When a program navigation key (top menu key) 20b is operated, a main menu (a guide screen) as shown in FIG. 3 is displayed on a monitor 3001 under the control of a screen control section 36. The main menu shown in FIG. 3 displays items “program chart”, “recording reservation list”, “My genre program list” “recommended services”, “favorite program list”, “drama series program list” and the like. In the main menu shown in FIG. 3, after operating the cursor key of the remote controller 20, for example, when “program chart” is selected, and then, the determination key 20DE is pressed, a current display is changed to the screen display as shown in FIG. 4.

FIG. 4 is a view illustrating a display example of a program chart that can be moved from the main menu shown in FIG. 3. The program chart screen shown in FIG. 4 displays electronic program guide information EPGI obtained through broadcast and/or communication line; date and time information DI that corresponds to the display contents; and content information CI that can be prepared according to a use state of a user who uses this program chart. In this display example, TV broadcast programs (EPGI compatible) for 5 channels are illustrated in broadcast time intervals (DI compatible) from 9 o'clock to 12 o'clock in the morning, Oct. 22, 2005, for example, and the relevant advertisements (CI compatible) of commodities for sale/commodities for rental are displayed on the same screen.

A user who has viewed this screen can have the feeling of purchasing a DVD video disc because a DVD sales advertisement of new series cinema “Moon Wars Episode 3” is provided on the same screen, when the user attempts to make a recording reservation of sold series cinema “Moon Wars Episode 2” that will be broadcast from 10 o'clock, October 22, for example. In this case, the user can purchase the above DVD disc by making an application to purchase the DVD disc on the Internet shop from the same screen or from a neighboring video shop. In addition, it is expected that the user have the feeling of checking out a software for rental because the user notices an advertisement of another much-talked-about cinema “Howl's Moving House” for rental.

In this case, as a part of content information CI, content providers, commodity sellers or the like who are aware in advance of what program will be broadcast in which broadcast channel in broadcast time interval from 9 o'clock to 12 o'clock in the morning, Oct. 22, 2005, can request an electronic program chart producer such as advertisement agency-relating affiliated companies, to display on the same program chart screen, advertisements or the like of other commodities and/or software such as video/music programs in which users interested in the programs broadcast in that time interval could show an interest. Doing this enables efficient, effective advertising rather than broadcasting commercial pictures irregularly and repeatedly in a concept that he that shoots oft at last shall hit the mark.

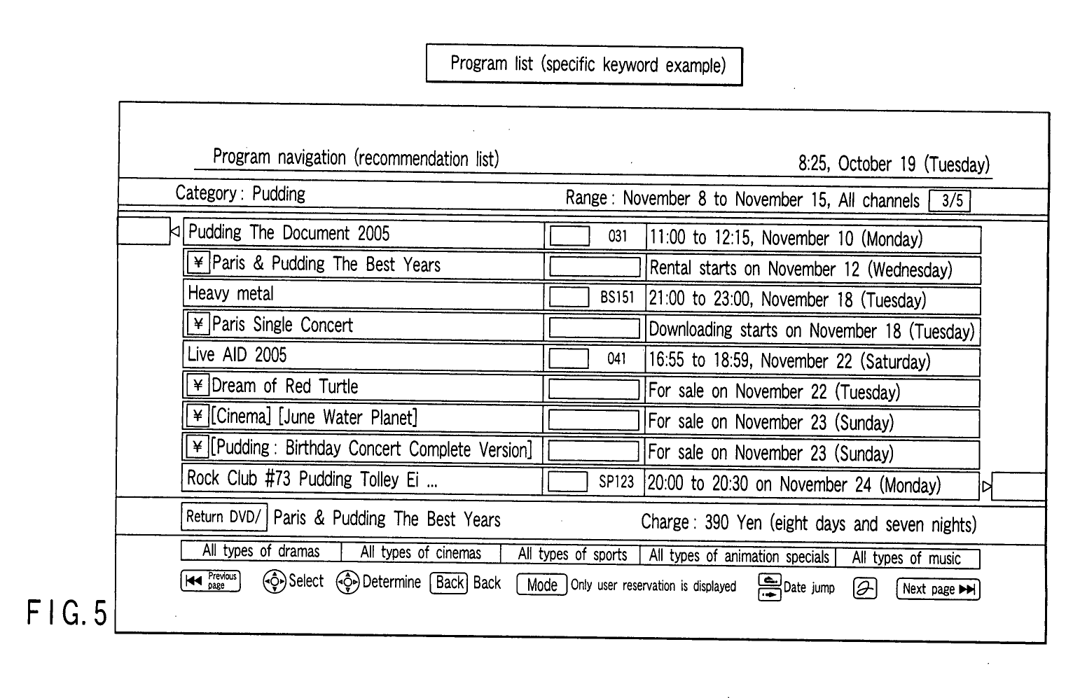

FIG. 5 is a view illustrating a display example of a program list that can be moved from the main menu shown in FIG. 3. This figure illustrates a program list (recommended list relating to pudding), obtained when a rock music singer “pudding”, for example, has been entered as a specific keyword by keyword setting in the main menu. The figure also illustrates the shown contents as recommended programs and advertisements obtained by the specific keyword “pudding”. That is, “Pudding the Document 2005” is displayed as a documentary program on which Pudding appears together with a broadcast channel and its broadcast time interval. In addition, advertisements of legendary rock music group “Paris” in which Pudding was a leader and “The Best Years” which covers hit numbers of Pudding are displayed together with date and time of starting rental of its related DVD software and charge for rental.

In addition, in this recommendation list, an advertisement of a concert video “Single Concert” of the “Paris” is displayed together with date and time of starting charged downloading of its related DVD software, and an advertisement of “Birthday Concert” that Pudding held after disbanding the Paris is displayed together with date and time of starting selling of its related DVD software. If a user has an interest in “The Best Years of Paris and Pudding”, for example, the user can rent the software by applying it for the rental from the screen shown in FIG. 5 or by visiting a neighboring rental shop at the date of starting the rental. This is provided as an example of a business model according to one embodiment of the invention.

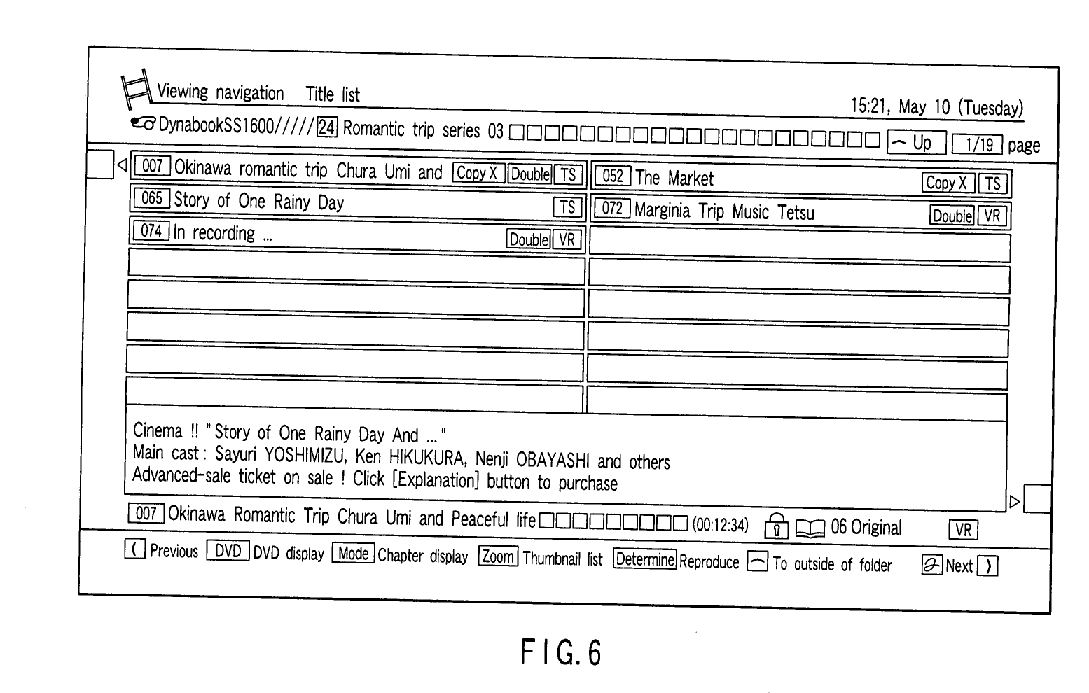

FIG. 6 is a view illustrating a display example of “a case in which an advertisement exists” that can be moved by a view navigation button 20d of a remote controller shown in FIG. 2. In this example, a user is outstandingly presented with an advertisement relating to a title placed in location in which a cursor appears on a display screen (Cinema Release!! “Story of One Rainy Day, and then . . . ”: Main Cast: Sayuri YOSHINAGA, . . . Advance Ticket on Sale: Click “Explain” button to purchase).

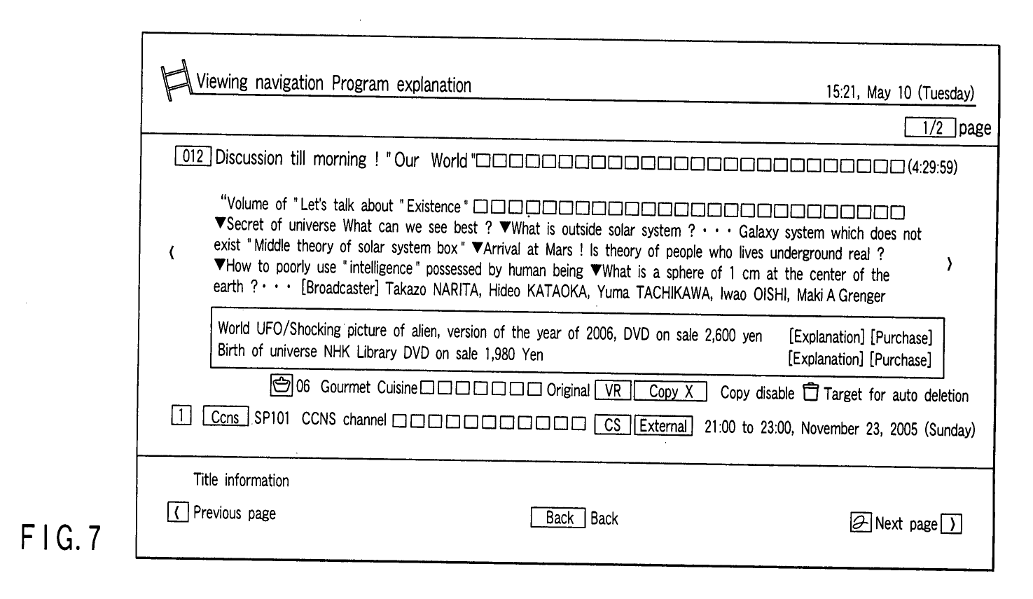

FIG. 7 is a view illustrating a display example of “an advertisement relating to a title on a cursor” that can be moved by pressing a program explanation button 20e, for example, of the remote controller shown in FIG. 2. This advertisement display screen includes a “Purchase” button (or icon). A user can purchase DVD of a corresponding title by a mail order by pointing a cursor to this purchase button through the remote controller operation shown in FIG. 2, for example, and then, pressing a determination button 20DE of the remote controller. This is provided as another example of a business model according to one embodiment of the invention.

FIG. 8 is a view illustrating an example of a system configuration to which a recording/reproducing method according to one embodiment of the invention is applied. In this system, a first client device such as a DVD recorder A1 and/or a second client device such as a digital TV A2 are properly connected to a server B via a network NT such as the Internet. The server B carries out provision of a program chart (EPG), provision of content information (CI), analysis of client data or the like. In addition, the client device A1 comprises a data accumulating section (database) 911 that accumulates information on operations of the client device such as operation of a CD/DVD reproducing apparatus 941, recording into a recording medium 1201 such as HDD or DVD-R/RW/RAM, or user operation via display in a GUI display system (monitor) 991); and that accumulates information from the server B. Further, the client device A2 comprises a data accumulating section (database) 912 that accumulates information of operations of the client device such as operation of a TV tuner and a picture processing section 942, recording into a recording medium 1202 such as HDD or DVD-R/RW/RAM, user operation via display of a GUI display system (monitor) 992, and that accumulates information from the server B.

In the system configuration shown in FIG. 8, the client devices (A1/A2) are configured to comprise one or more of the following functions:

an operating function of integrally displaying contents or service information other than a broadcast, and making a search for a program chart, a program list, and a program; and a display interface function;

a function of specifying display/non-display, display sequence, display information quantity, and display contents of specific contents or services by user setting or server side setting (user capable of server setting);

a database that accumulates user preferences;

a function of enabling recording reservation, execution of reservation, execution of reproduction of recorded contents, deletion of recorded contents, storing the recorded contents to a portable medium (such as DVD/R/RW/RAM), management of library (meta data) information, reproduction of portable medium such as CD/DVD, and accumulation and/or server transmission of content and service purchase history information, searched information, and keywords for auto search, accumulation/registration of user's system use state, library information or the like can be carried out by data accumulation 96 shown in FIG. 9 described later; and

a function of automatically or manually acquiring recommended information, by content providers, commodity sellers or the like and/or information users want from a server.

In addition, in the system configuration shown in FIG. 8, the server (B) is configured to comprise one or more of the following functions:

a function of specifying a client;

a function of accumulating client information;

a function of accumulating and transmitting program data for program chart system;

a function of acquiring/accumulating a variety of content data other than program data;

a function of analyzing accumulated client information and a variety of content information, associating the information, adding a degree of recommendation, and distributing the resultant information to a client;

a function of supporting purchase of contents or application for rental from a client; and

a billing system.

FIG. 9 is a view illustrating an operational example (operating procedure example) of the system configuration shown in FIG. 8.

1 Client devices (A1/A2):

Program chart data is acquired from the server B, and the acquired data is accumulated (91). From the program chart data, recording reservation information capable of specifying a program is accumulated based on unique channel codes and date and time information (91 to 93 and 96). The accumulated data is periodically transmitted to the server (d);

Metadata contained in commercially available software such as user viewed DVD or CD (information acquired by utilizing data service such as CDDB) is stored (94 and 96);

A user specified keyword for automatic search is stored (95 and 96);

The above-described equipment use information is continuously and periodically transmitted to the server (d); and

Additional information such as equipment use area, gender, age/generation, blood type, and constellation is transmitted to the server as needed (d).

2 Server (B):

A client is specified from equipment information and additional information;

A user preference is specified from a client based on updated recording reservation information and meta data such as a keyword, DVD, or CD (97); and

From among content information acquired by a server and content information such as DVDBB, content information is extracted in accordance with the preference acquired by a client. Further, a degree of importance (a degree of recommendation) is added to content information in accordance with the user preference and trend. Then, content information CI is transmitted to a client device A as one item of program chart information obtained by specifying a time interval/display area in accordance with a use frequency, a recording frequency and the like of a client (f).

3 Integrated user interface (UI) using client device (A1/A2) side to program chart/program list interface:

Transmitted program information (including content information CI) is displayed. At this time, content and service information are displayed in a program chart format and in a program list format in accordance with entirety, genre, content type, specific keyword, and specific theme (99);

The following various elements can be displayed in listings or can be displayed in a narrowing manner in the form such that they are inserted in a general program chart (refer to FIG. 5 or the like);

A variety of elements are cyclically displayed;

A direct link from a variety of displayed elements and jump to a list of a plurality of items in a program list form can be carried out;

A display mode can be changed with one button click; and

Rental, purchase, downloading and the like can be carried out by selecting content information (refer to FIGS. 6, 7 or the like).

Now, a specific operating example (an operating procedure example) of the system configuration shown in FIG. 8 will be described with reference to FIG. 9.

A client (a user) downloads (91) program data (90);

A client records (93) a TV broadcast on which “Mika NAKASHIMA” appears in accordance with a program chart (92), and then, carries out data accumulation (96);

A client reproduces and views “Mika NAKASHIMA” by CD (94), carries out data acquisition from CDDB, and carries out data accumulation (96);

A client registers “Mika NAKASHIMA” in keyword (96), and then, carries out data accumulation (96);

Accumulated data (96) is transmitted to a server (d);

A server analyzes client preferences (97) and extracts “Mika NAKASHIMA”;

Information relating to “Mika NAKASHIMA” is acquired from content information, and a degree of recommendation is added (97), for example, “Mika NAKASHIMA” concert ticket for sale—degree of recommendation high, purchase of “Mika NAKASHIMA” live DVD—degree of recommendation middle, “Mika NAKASHIMA” new album sales information—degree of recommendation Low;

Content information is transmitted to a client (f);

“Mika NAKASHIMA” concert ticket for sale, “purchase of “Mika NAKASHIMA” live DVD, and “Mika NAKASHIMA” new album sales information” are displayed in this order in a specified area in accordance with the degree of recommendation from a client program chart (98 and 99); and

When a client selects “live DVD” by an operation of a remote controller, and then, presses a determination button of the remote controller, a current screen moves to a purchase screen (refer to FIGS. 6, 7 or the like). From this purchase screen, a user can purchase one's preferential software (commodity) (download charged software or purchase a desired disc, or purchase a desired ticket), or alternatively, can make an application for rental (111 to 113; 110, and 120).

As a purchase processing operation described here, there can be employed a processing operation of a microphone terminal or the like to the client side, although not shown, enabling a purchase in units of items of Karaoke (identical data to that used in Karaoke box).

FIG. 10 is a view illustrating title information recorded to be associated with a title of a program recorded on the user side. This figure shows a specific example of title information written into management information relevant to a recorded title (part of information that can be acquired from EPG) in the case where reserved recording has been carried out by using the electronic guide information/electronic program guide (EPG) obtained from a program chart site via a broadcast channel or via the Internet. That is, for example, with respect to a program entitled “Story of One Rainy Day” broadcast from 21:00 to 22:54, Aug. 31, 2005 on a broadcast channel X, a channel code of which is represented by “A040-010”, title information including the information illustrated in FIG. 10 is recorded in the relevant management information. Advertisement ID (102-432) handled by a sponsor of that program is added to the title information. When this advertisement ID is specified, it is possible to automatically determine what kind of advertisement, when and how, is presented to a user.

How to record and hold the above management information (including the title information and any other information shown in FIG. 10) depends on the configuration of the user side client device. For example, in an optical disc recorder that conforms to DVD-VR standard, this management information can be recorded and held in video manager information (RTR_VMGI). In the equipment shown in FIG. 1, the recording/holding of this management information can be automatically carried out by using firmware (such as a recording time management information control section 34) of the microcomputer block 30 (a holding location is RAM 31, for example). Alternatively, the recording/holding of the above management information can be automatically carried out by a user information data accumulation processing operation 96 in the system configuration shown in FIG. 9.

When the information including the contents shown in FIG. 10 is sent from a broadcast channel, even if recording reservation using EPG is not made, the title information as shown in FIG. 10 can be written into management information (by the user side client device) with respect to a broadcast program recorded at an arbitrary timing.

FIG. 11 is a view illustrating advertisement information that can be linked in advertisement ID included in the title information shown in FIG. 10. This advertisement information contains the contents of advertisement or the like such as advertisement due date of issuing the advertisement; an advertisement viewing flag of checking whether or not a user has viewed the advertisement (whether or not the title has been reproduced); a forcible display flag of determining whether or not the advertisement is forcibly displayed immediately before starting the title reproduction regardless of the user intention; and a keyword associated with the contents of the title (properly applicable to making a search or a matching check for content information, user preference information and the like). This advertisement information can be configured to be held in a database of the server side processing operation 97 shown in FIG. 9, for example, and/or a database (memory) of the client side processing operation 98 (the information can be held in a RAM 31 in the equipment configuration shown in FIG. 1).

Specifically, when “102-432” is specified by advertisement ID included in the title information shown in FIG. 10, the advertisement information on No. 1 shown in FIG. 11 linked with this advertisement ID is selected as advertisement information associated with a recorded title of “Story of One Rainy Day”. Here, when an original of the recorded title “Story of One Rainy Day” is a television drama, in the case where an attempt is made to produce an advertisement after cinema release of its theater version has been determined, the advertisement information on No. 1 shown in FIG. 11 is linked with the recorded title by advertisement ID included in the title information shown in FIG. 10 for a period whose advertisement effect is high (for example, one month before the release).

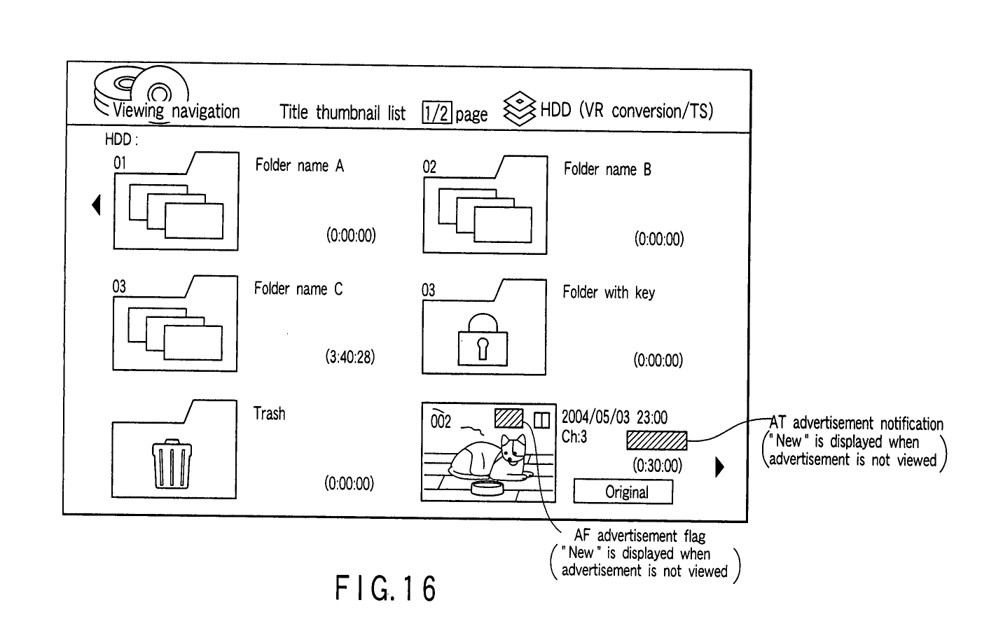

When a user selects a thumbnail of that recorded title (such as a lower right thumbnail shown in FIG. 16), and then, instructs starting reproduction, a dialog (not shown) that prompts the user to select whether or not to view the advertisement (not shown) is displayed on a screen (in the case where a forcible display flag is “optionally set”). If the user selects not to view the advertisement, and makes title reproduction, the advertisement viewing flag remains “undone: 0”. Alternatively, when the user selects to view the advertisement, advertisement reproduction is temporarily carried out, and then, reproduction of a main part of the title is started. In this case, the advertisement viewing flag is set to “done: 1”. In the case where the advertisement flag has been set to “done: 1” or in a case where the advertisement period has been expired, the above-described “inquiry dialog that asks whether or not to view the advertisement” can be configured not to be displayed on a screen. (Even in the case where the advertisement viewing flag has been set to “done: 1”, the above-described “inquiry dialog that asks whether or not to view the advertisement” may be displayed on a screen within the advertisement period.)

In addition, as is the case with advertisement information on No. 4 shown in FIG. 11, in which a forcible display flag is “Forcible”, the corresponding advertisement is forcibly displayed before starting title reproduction. If a user has viewed that advertisement when the forcible display flag is initially “forcibly set”, a configuration can be provided so that the advertisement viewing flag is reset to “done: 1”, and then, the forcible display flag is changed to “optionally set”.

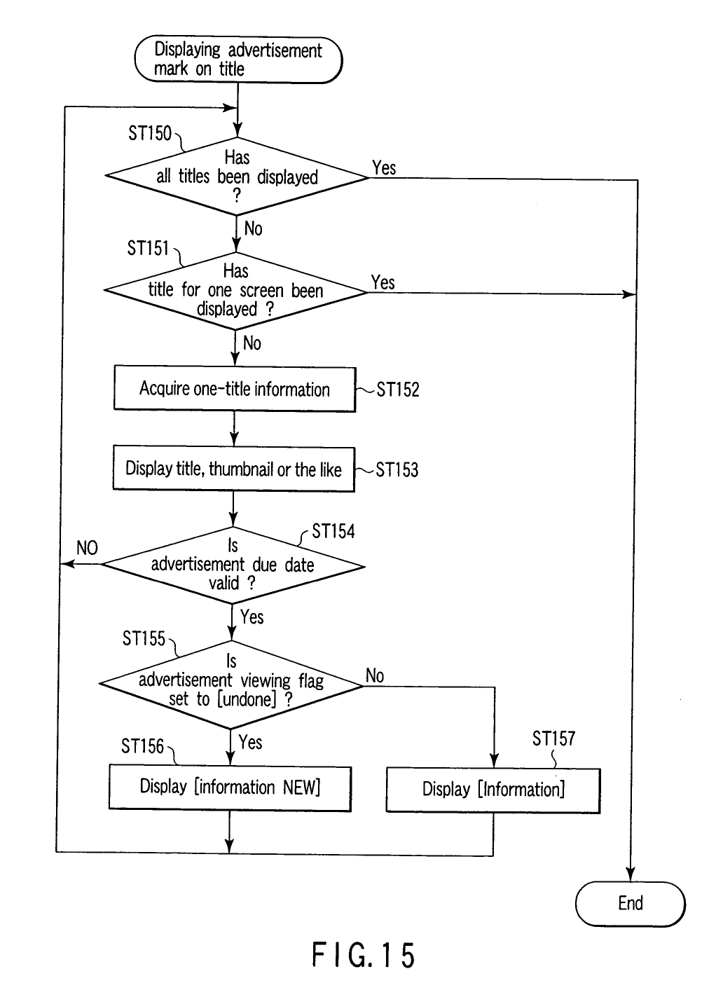

In this manner, a system is provided such that the user can view that advertisement at least once. (A specific example of a method for using an advertisement viewing flag shown in FIG. 11 will be described later with reference to FIG. 15.)

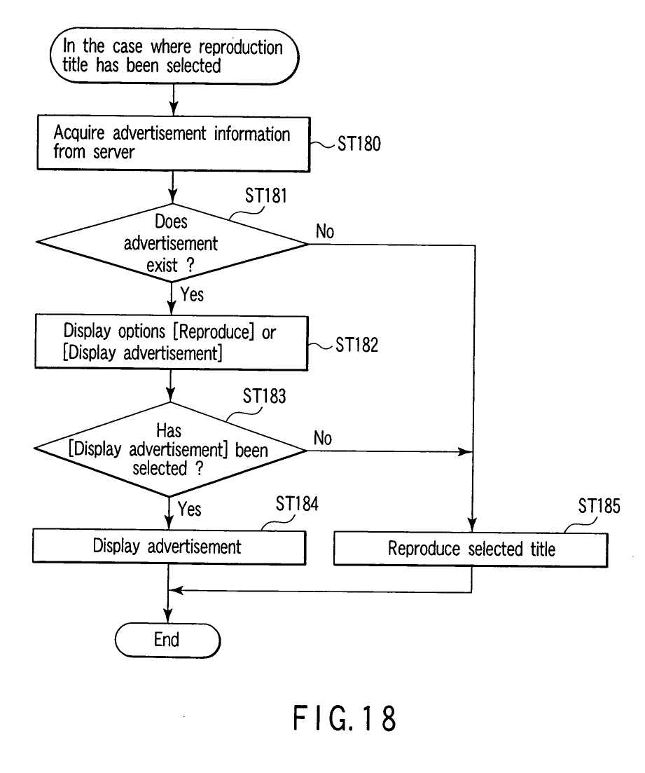

FIG. 18 is a flow chart illustrating a specific example of a processing operation of prompting a user to select reproduction of title or advertisement display relating to the title. When a specific title is selected as a reproduction target from among one or more recorded titles, the user side client device acquires advertisement information from a server (block ST180). When an advertisement exists in the acquired advertisement information (FIG. 11) (when advertisement ID other than “0” exists in the advertisement information) (Yes in block ST181), a dialogue (not shown) indicating an option of whether to reproduce the selected title or display an advertisement of the selected title is displayed on a screen (block ST182).

Here, when the user selects “display an advertisement” by cursor key operation of the remote controller (FIG. 2), and then, presses a determination button 20DE of the remote controller (Yes in block ST183), the advertisement corresponding to the advertisement ID (for example, “New cinema release!! . . . ” shown in FIG. 6) is displayed on a screen. On the other hand, when “display an advertisement” is not selected (No in block ST183), or alternatively, when no advertisement exists in the advertisement information acquired from a server (when only advertisement ID indicating “0” exists) (No in block ST181), the selected recorded title is reproduced (block ST185).

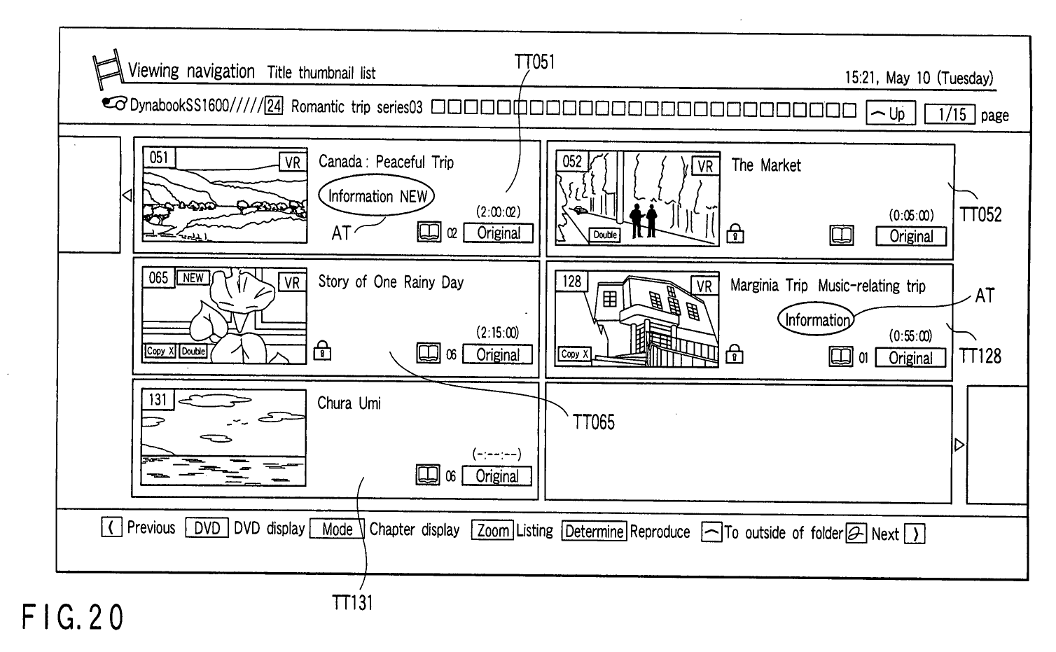

FIG. 20 is a view illustrating a display example of a title thumbnail list in the case where an advertisement exists. A file of the recorded title that corresponds to the title thumbnail shown in FIG. 20 is stored in a directory of a folder name A shown in FIG. 16, for example. Now, assume that a user has pressed the determination button 20DE of the remote controller shown in FIG. 2 in a state in which a cursor is pointed to an icon of the folder name A shown in FIG. 16. Then, the thumbnail of the recorded title managed in file by that folder is displayed on a screen, as shown in FIG. 20. In this example, five recorded titles are stored in the folder name A, and advertisement notification AT is attached to two (TT051 and TT128) of them.

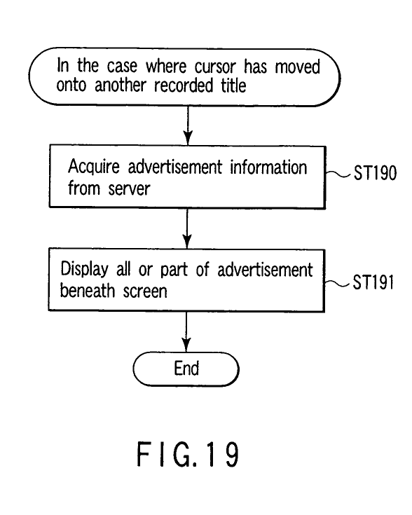

FIG. 19 is a flow chart illustrating a specific example of a processing operation of displaying advertisement information in accordance with a recorded title placed in cursor location on a display screen. Now, assume that a user has moved a cursor from the recorded title TT065 to the recorded title TT128 shown in FIG. 20 by the cursor key operation of the remote controller. (Due to this movement, the edging and/or coloring of the thumbnails selected by the cursor are/is changed, and which item(s) is(are) selected by the cursor can be easily identified visually). The advertisement notification AT is attached to this title TT128. (That is, an advertisement as illustrated in FIG. 11 exists).

In this case, the microcomputer block 30 shown in FIG. 1 or the client device shown in FIG. 9 acquires (downloads) the advertisement information (FIG. 11) from a server (block ST190). Then, for example, the corresponding advertisement (for example, guide to super low-price overseas trip of travel agencies, although not shown) is displayed on part or whole of the screen shown in FIG. 6 (block ST191).

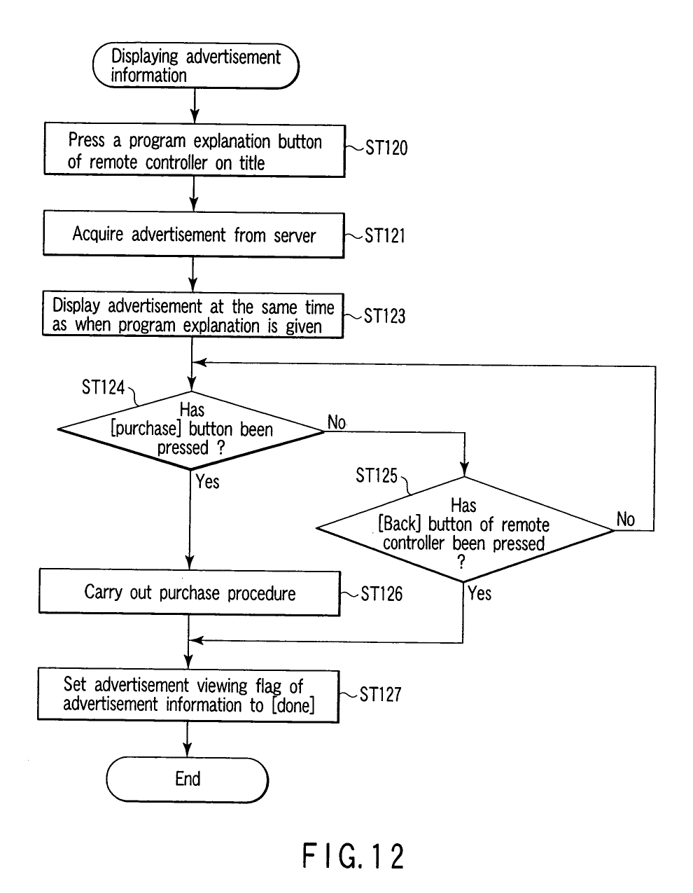

FIG. 12 is a flow chart illustrating a specific example of a processing operation of displaying advertisement information. For example, in screen display of a title list shown in FIG. 6, in the case where a cursor is placed on a title at the left middle stage (Story of One Rainy Day), a dialog box of an advertisement as illustrated at the lower stage from the center shown in FIG. 6 is properly displayed.

In addition, assume that, although not shown in FIG. 6, in the case where a program title of “Discussion Until Morning! Our World” exists as one of the recorded programs in a title list, a program explanation button 20e of the remote controller shown in FIG. 2 has been pressed in a state in which the cursor is placed on this program title (block ST120). Then, the firmware of the microcomputer 30 shown in FIG. 1 or a control program of the client device shown in FIG. 9 acquires advertisement information (data structure information as shown in FIG. 11) from the server (block ST121), and displays on a screen the advertisement shown in FIG. 7 (such as “World UFO Shocking Video Image of Arian, 2006 version DVD for Sale, 2,600 Yen” at the same time when a program explanation sentence is displayed (block ST123).

When a user who has viewed the above screen displayed advertisement moves a cursor to a “[Purchase]” portion (icon) in the advertisement shown in FIG. 7, and then, presses a determination button 20DE by remote controller operation (Yes in block ST124), procedures for purchasing the commodity are taken (block ST126). Alternatively, when the user who has viewed the advertisement does not want to purchase it (No in block ST124), and then, presses a “back” button of the remote controller (Yes in block ST125), the procedures for purchasing the advertised commodity are not taken.

If the processing operations shown in blocks ST123 to ST126 have been carried out, regardless of whether the user has taken the procedures for purchasing the advertised commodity, it is possible to judge that the user has viewed that advertisement. In this case, the advertisement flag shown in FIG. 11 is rewritten from “undone: 0” to “done: 1” (block ST127), and the processing operation shown in FIG. 12 is terminated.

FIG. 13 is a flow chart illustrating a specific example of an advertisement acquisition processing operation from a server. The left side processing operations (ST130 and ST134) shown in this figure is provided as the user side (client device) processing operation and the right side processing operation (ST131 to St133) is provided as the server side processing operation. Exchange between the user side and the server side can be carried out by using a communication line such as the Internet. Alternatively, a configuration can be provided so as to use a telephone line for communication from the user to the server and so as to use a broadcasting wave for data provision from the server to the user.

After a broadcast program has been recorded from the user side client device (such as an optical disc recorder having a configuration as shown in FIG. 1), when the user selects that recorded title as a reproduction target, information on the selected title (such as a broadcast CH code, a broadcasting time, advertisement ID, and a device code for specifying a client device) is sent from the user (client) to the server via a communication line (block ST130).

On the server side, user preferences (or client preferences) are extracted from the sent device codes (device information such as a manufacturer code of a recording device that the user uses, a product code, and a manufacturing number) (block ST131). Here, information on the user preferences is requested in advance from use information specific to the user, the information having been sent from a use information data accumulation processing operation 96 to a user information analysis/content data acquisition/data creation (with degree of recommendation) processing operation 97 shown in FIG. 9.

Subsequently, on the server side, for example, with reference to program chart data 90, the corresponding title (Story of One Rainy Day shown in example of FIG. 10) is requested from the sent CH code and broadcasting time, and its associated advertisements (such as advanced-sale ticket of “Story of One Rainy Dai) corresponding to advertisement ID “102-432” in examples of FIGS. 10, 11, and 6 is selected (block ST132). At this time, when a large number of advertisements (for example, four advertisements) have been selected, such advertisements are narrowed to a small number of advertisements (for example, three or less advertisements) whose advertisement effect is expected to be high in response to such user selection at this time point. In this manner, from among the selected advertisements, only those suitable to the user preferences are sent out to the client device (block ST133).

The advertisements from the server (narrowed so as to match the user preferences) are acquired on the user side, and the acquired advertisement is properly displayed on the display screen of the client device (block ST134).

Advertisement information is not limited to text. A variety of advertisements include those having a picture having a high resolution, a mobile picture, and/or a voice. In such a case, it takes long for the client device to download the advertisement information from the server. On the other hand, the advertising side has strong tendency to repeatedly present the user side with the same contents. Thus, it is wasteful to download the same advertisement every time advertisement is acquired.

Therefore, on the client side, a configuration can be provided so as to download difference information that does not overlap with the acquired advertisement information. Specifically, a unique advertisement ID (refer to FIG. 11) is attached to each advertisement so that the acquired advertisement information and advertisement information that is not acquired can be identified with each other from this advertisement ID. In the processing block ST130 shown in FIG. 13, the client device sends one's own advertisement ID to a server. Thus, in the processing block ST132 on the server side, a processing operation of deleting advertisement of the advertisement ID sent from the user side (if any) can be carried out. At this time, when the advertisements selected in block ST132 does not contain ID identical to the advertisement ID sent from the user side to the server side, all of the selected advertisements are sent from the server side to the user side.

In the case where transfer has been interrupted under some circumstance during transfer of one advertisement information item indicated by the same advertisement ID (such as disconnection of communication link due to a user side power failure), information on where such interruption has occurred is provided to the server side, whereby the remaining advertisement information which has not been sent to the user side yet (one type of difference information) can be sent instead of retrying transfer of advertisement information from the start at the time of restarting transfer.

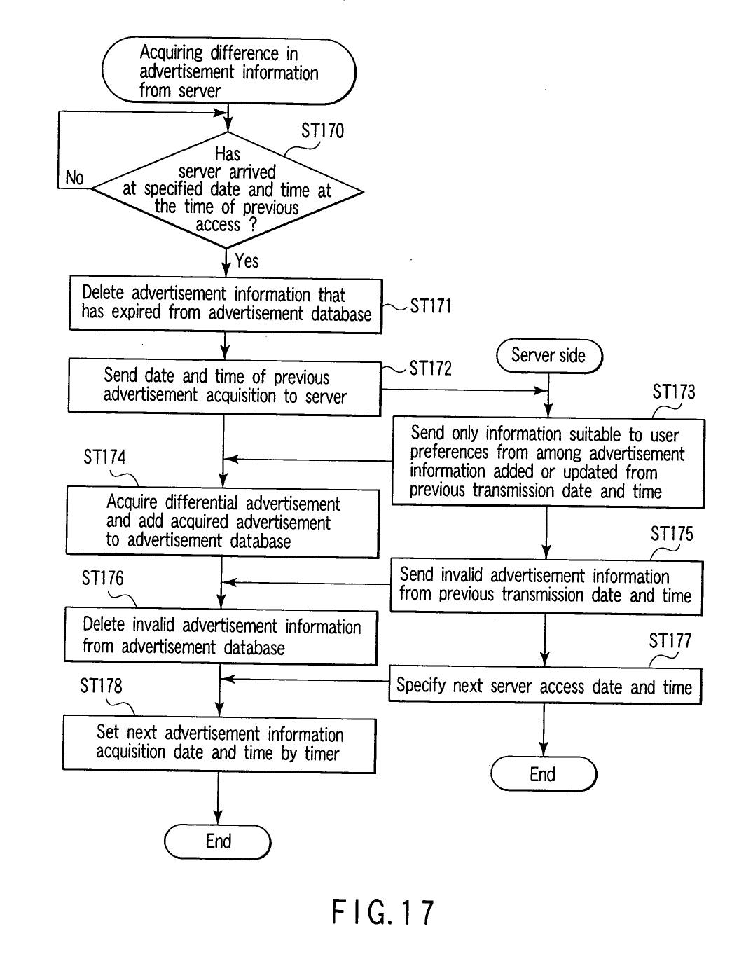

FIG. 17 is a flow chart illustrating a specific example of a processing operation of acquiring a difference in advertisement information from a server. This processing operation is provided as another example of “downloading differential advertisement information” described with respect to block ST134 shown in FIG. 13. That is, when date and time (for example, 18:00 or 21:00 everyday), which has been specified by a server when the user side client device (FIG. 8 or FIG. 9) has last accessed the server, has come (Yes in block ST170), advertisement information indicating expiration is deleted from an advertisement database on the client device side (911 shown in FIG. 8, for example) (block ST171). For example, if a current date and time is Oct. 11, 2005, advertisement information indicating the advertisement ID=“102-432” shown in FIG. 11 has expired, and thus, is deleted from the user side database.

Subsequently, the user's client device sends the date and time of the previous advertisement information acquisition (hour, minutes, seconds is provided as needed, in addition to year, month, day) to the server (block ST172). The server side extracts only information suitable to preferences of the user from among the advertisement information added and/or updated from the date and time of previous transmission to the user, and sends the extracted information to the user (block ST173). The user side acquires advertisement information that does not exist in one's own database (namely, a difference from the existing advertisement information) from among the advertisement information sent from the server, and adds the acquired information to one's own database (for example, a database constructed in-911 shown in FIG. 8 or in 98 or 120 shown in FIG. 9) (block ST174).

In addition, if advertisement information invalidated on and after the date and time of previous transmission is sent from the user to the user's client device (block ST175), the advertisement information invalidated from the user side advertisement database is deleted (which item of advertisement information has been invalidated can be specified by advertisement ID).

Then, the server notifies to the user side a specified date and time of next access (block ST177). Then, the user's client device sets the date and time of next advertisement information acquisition in a timer (not shown) (used in the judgment in the next block ST170) (block ST178), and terminates the processing operation shown in FIG. 17.

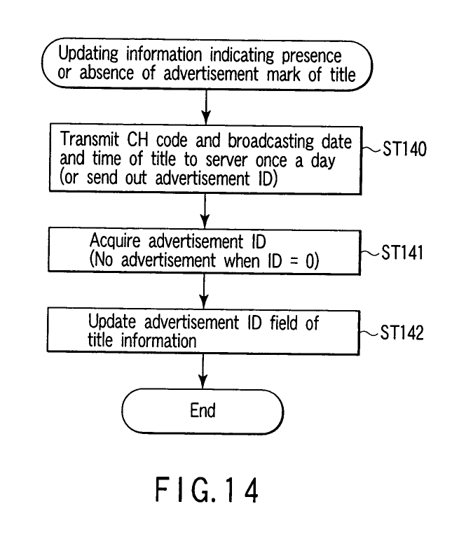

FIG. 14 is a flow chart illustrating a specific example of a processing operation of updating information indicating the presence or absence of an advertisement mark of a title. Here, the user side client device sends to the server side at least part (such as a title name, a CH code, a recording date and time, and a recording time) of title information (FIG. 10) once (or a plurality of times) everyday (block ST140). When this title information includes advertisement ID, the absence of advertisement is indicated by ID=0, and the presence of an advertisement is recognized by a unique ID other than 0 (block ST141). When advertisement ID corresponding to the sent advertisement ID exists in the server side advertisement information (FIG. 11), the server updates an advertisement ID field of title information (FIG. 10) (in the case where advertisement is present in block ST142). When advertisement ID corresponding to the sent advertisement ID does not exist in the server side advertisement information (FIG. 11), the server updates the advertisement ID field of title information (FIG. 10) to ID=0 (in the case where advertisement is absent in block ST142).

When advertisement ID of the user side title information is updated to “0”, an advertisement flag AF and/or an advertisement notification AT are/is deleted from the thumbnail shown in FIG. 16 described later. In addition, in the case where advertisement ID of the user side title information is updated to a number other than “0”, if the advertisement viewing flag in the advertisement information (FIG. 11) is in an “undone” state, the advertisement flag AF and/or the advertisement notification AT are displayed, the flag and/or notification having “New” attached to the thumbnail shown in FIG. 16.

FIG. 15 is a flow chart illustrating a specific example of a processing operation of displaying an advertisement mark on a title. In title display (for example, a title thumbnail list shown in FIG. 16) of the user side (a client device shown in FIG. 9 or a recorder shown in FIG. 1), the processing operations shown in FIG. 15 (blocks ST152 to St157) are executed until titles for at least one screen display has been completely displayed. That is, when the display of the title thumbnails for one screen has not completed yet (No in block ST151), information for one title (management information) is acquired (block ST152), and screen display of a title text or thumbnail of the recorded title is carried out (block ST153: FIG. 16 illustrates a case in which there exists only one thumbnail of a recorded title other than a folder storing a file of the recorded title).

Although not shown in FIG. 1 or FIG. 9, a client device or recorder comprises a timer so as to enable comparison between a current date and time of the timer and an advertisement due date of advertisement information (FIG. 11). If the current date and time of the timer which is not shown is within the above advertisement due date, it is judged that the advertisement due date of the corresponding advertisement ID is valid (Yes in block ST154), and an advertisement viewing flag (FIG. 11) is checked (block ST155).

If the advertisement viewing flag (FIG. 11) is “undone: 0” (Yes in block ST155), an advertisement flag AF with “New” is displayed in the thumbnail of the recorded title shown in FIG. 16 and/or an advertisement notification AT with “New” is described (block ST156). On the other hand, if the advertisement viewing flag (FIG. 11) is “done: 1” (No in block ST155), an advertisement flag AF without “New” is displayed in the thumbnail of the recorded title shown in FIG. 16 and/or an advertisement notification At without “New” is described (block ST157).

Examples of yet other embodiments include:

The user side (client device) may acquire advertisements from a server on a one by one basis in real time or may periodically or irregularly acquire all advertisements at one time.

The user side (client device) may not be connected to a network. In this case, the user side may acquire from broadcasting waves only advertisement information that matches title information with reference to a keyword or advertisement ID.

The user side (client device) may acquire advertisement information by notifying advertisement ID to a server.

Features of another embodiment include:

(1) A problem that an advertisement could be obsolete at the time of reproduction can be solved by acquiring advertisement information at the time of actual reproduction so as to display the latest CM.

(2) A problem that a CM effect is lowered, since the CM is displayed regardless of user gender, age, or preferences (or that a CM effect is unknown) can be solved by using preference information utilizing a reservation or recording result as well as fixed information such as gender and age so as to display a CM suitable to individual users.

(3) A problem that, even if a CM is viewed, purchasing cannot be carried out on the spot, and a CM effect could be lowered, can be solved by enabling the purchase of a item on the spot.

Further,

(4) Sales information relating to a recorded title and contents (such as a broadcaster) as well as CM can also be provided.

(5) Advertisement information can also be displayed when a title list is displayed as well as when reproduction is carried out.

(6) Advertisement information is irregularly acquired and/or updated once or a plurality of times a day in real time, thereby making it possible to always provide the latest information.

(7) A user can select and display advertisement information.

Features of another embodiment include:

1) When a reproduction title is selected, information capable of specifying the title (such as a CH code or a broadcasting date and time at the time of recording) is sent to a server via a network, and advertisement information associated therewith can be acquired and displayed via the server.

2) Information capable of specifying a device or a user is sent to a server together with information capable of specifying a title, whereby advertisement information according to individual-users can be acquired via the server. This acquisition presumes that information indicating user preferences such as imaging/viewing reservation information and recording information or reproduction information is sent to the server or that gender, age or the like has been registered in advance in the server.

3) Only an advertisement (such as gender, age, and preferences) suitable to a user can be displayed from among the advertisement information relating to reproduction title information (such as contents, broadcaster, and sponsors).

4) When a reproduction title is selected, reproduction or advertisement information display can be selected.

5) Advertisement information can be displayed by pointing a cursor to a recorded title.

6) Advertisement information is displayed, whereby an item can be directly purchased from the display.

7) The presence or absence of advertisement information can be represented on a recorded title or a thumbnail.

8) The presence or absence of new advertisement information can be represented on a recorded title or a thumbnail.

9) All or part of advertisement information can be periodically or irregularly acquired via a server (via a network) or via a broadcasting wave.

10) A difference in advertisement information can be acquired via a server (a time interval for downloading advertisement information via a communication line can be reduced).

11) Advertisement information can contain additional information on validity, forcible display enable/disable, or keyword (optionally). The advertisement information can be composed of a text, a still picture, a voice, a mobile picture, sales information and the like.

12) Advertisement ID is assigned to each one of the programs in a program chart, and advertisement ID is also added to a recorded title as well, whereby advertisement information can be specified or acquired by the same ID.

The above functions can be applied without being limited to recorded titles such as video on-demand (VOD) VOD other than a video recorder.

For users,

The information which is the latest and which is suitable to the user can be properly displayed or selectively displayed, and information that could not be generally known can be obtained (trivial information is not easily obtained).

A desired item can be easily purchased on the spot.

For content (program) sponsors,

a precise and latest CM according to individual users can be displayed.

A CM viewer rating can be reliably obtained (at the time of CM real time acquisition).

A purchase of an item for sale is stimulated.

For broadcast companies, program producers, and cooperators,

CM and Sales related with contents such as music, broadcasters, advertisement and/or sales service providers, can be provided.

Example 1) CD of theme song of drama for sale.

Example 2) Tickets for sale when drama is produced as cinema.

Example 3) Broadcaster's concert information display.

A wide response to requests from individual advertisers can be made in a variety of advertisement modes (charges).

A commission income at the time of establishment of purchase can be expected.

A very large amount of user information can be accumulated.

In yet other embodiments:

1) The latest advertisement is acquired at the time of selection of a reproduction title, thereby making it possible to prevent obsolescence of advertisement.

2) An advertisement according to reproduction title and user information (gender, age, and preferences) is displayed, whereby a proper advertisement effect can be attained.

3) A high advertisement viewer rating (advertisement effect) can be obtained.

4) Sales of associated commodities can be provided immediately after viewing an advertisement. (High advertisement effect is attained, and convenience to users is obtained).

5) The above-described effects (excluding advertisement viewer rating) can be attained by using a broadcasting wave (in a unidirectional manner) even without a network (in a bidirectional manner).

For individual users, the information which is the latest and which is suitable to the users can be properly displayed or selectively displayed, and information that cannot be generally known (or that is easily missed) can be provided.

The invention is not limited to the embodiment described previously. At the stage of carrying out the invention currently or in the future, on the basis of a technique available at that time point, various modifications can occur without departing from the spirit of the invention. In addition, embodiments may be carried out while they are properly combined with each other if any, and an effect caused by such combination is attained. Further, inventions at various stages are included in the above-described embodiments, and a variety of inventions can be excerpted from proper combination of constituent elements presented in the embodiments. For example, even if some constituent elements may be deleted from all the constituent elements presented in the embodiments, a configuration excluding these deleted constituent elements can be excerpted as an invention.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A method of providing advertisements associated with electronic content comprising:
associating at least a first advertisement with electronic content stored on a recording medium;
sending metadata associated with the electronic content to a server; and
receiving at least a second advertisement from the server wherein the second advertisement is based at least in part on the metadata; and
replacing the first advertisement with the second advertisement such that the second advertisement is displayed when a user views the electronic content.

2. The method according to claim 1 wherein the replacing of said first advertisement with the second advertisement occurs based on the expiration of a time period associated with the first advertisement.

3. The method according to claim 1 wherein the replacing of said first advertisement with the second advertisement occurs based on whether the first advertisement has been displayed.

4. The method according to claim 1 wherein the second advertisement has a different identifier than the first advertisement.

5. The method according to claim 1 wherein the electronic content is obtained from at least one of the group consisting of a DVD, a CD, and a hard disk.

6. The method according to claim 1 wherein the metadata is the title of the electronic content.

7. The method according to claim 1, further comprising sending preference information to the server wherein the preference information is selected from at least one of the group consisting of recording reservation information, recording information, reproduction information, user preferences, user personal information, user age and user gender.

8. The method according to claim 7 wherein the second advertisement is selected based on the preference information.

9. The method according to claim 2, wherein a user device comprises an information accumulating section which is configured to handle the advertisements sent from the server as differential information that does not overlap with advertisement information already accumulated in the information accumulating section.

10. The method according to claim 1, wherein the second advertisement is selected from at least one of the group consisting of text, a still picture, a voice, a mobile picture, sales information, and wherein the advertisement further includes information about at least one selected from the group consisting of an advertisement, forcible display enable or disable of the advertisement, and a keyword available to make a search for the advertisement.

11. The method according to claim 1, wherein the advertisement includes an advertisement identifier and wherein a user device is configured to combine the advertisement identifier with the metadata.

12. The method according to claim 1, wherein a text based recorded title is assigned to a title of the video program or a thumbnail image corresponding thereto and wherein the presence or absence of the advertisement information or an unread notification is associated with at least one of the group consisting of the recorded title text, a flag indicating the presence or absence of the advertisement information, and a flag indicating the unread notification is displayed on the thumbnail image.

13. The method according to claim 1, wherein titles of the recorded video programs are displayed and wherein the advertisement on which a cursor is placed is displayed while a title is displayed.

14. The method according to claim 1, wherein a purchase display for accepting a purchase of an advertised commodity is provided on a display.

15. A recording apparatus comprising:
processor circuitry configured to retrieve electronic content stored on a recording medium wherein the electronic content is associated with at least a first advertisement, the processor circuitry further configured to retrieve metadata associated with the electronic content;
processor circuitry configured to send the metadata to a server;
processor circuitry configured to receive a second advertisement from the server wherein the second advertisement is based at least in part on the metadata; and
processor circuitry configured to replace the first advertisement with a second advertisement such that the second advertisement is displayed when a user views the electronic content.

16. The recording apparatus according to claim 15 further comprising:
processor circuitry configured to display electronic guide information;
processor circuitry configured to process electronic content that corresponds to the electronic guide information; and
processor circuitry configured to displays advertisements associated with the electronic content.

17. The recording apparatus according to claim 15 wherein the electronic content is obtained from at least one of the group consisting of a DVD, a CD, and a hard disk.

18. The recording apparatus of claim 15 wherein the metadata is the title of the electronic content.

19. An apparatus comprising:
processor circuitry configured to display electronic guide information;
one or more tuners configured to receive a broadcast;
a monitor configured to display the broadcast information; and
processor circuitry configured to detect metadata associated with the broadcast information and further configured to send the metadata to a server so as to obtain advertisement information associated with the metadata.

20. The apparatus of claim 19 wherein the metadata is the title of the broadcast information.
